(19) United States
(12) Patent Application Publication
(10) Pub. No.: US 2006/0168193 A1
(43) Pub. Date: Jul. 27, 2006

(54) Methods, computer program products, and systems for detecting incidents within a communications network

(76) Inventor: Gerald Starling, Hampton, GA (US)

Correspondence Address: BELLSOUTH CORPORATION, P.O. BOX 2903, MINNEAPOLIS, MN, 55402-0903, US

(21) Appl. No.: 10/996,529

(22) Filed: Nov. 23, 2004

(51) Int. Cl. G06F 15/173

(52) U.S. Cl. 709/224

(57) ABSTRACT

Methods, systems, and computer program products for detecting an incident within a communications network are provided. A method involves establishing a fingerprint for at least one of the network elements associated with the communications network. Each fingerprint established includes at least one message signaling characteristic and/or at least one message signaling parameter of one of the network elements. The method also involves monitoring message communications within the communications network, comparing the message communications monitored to each fingerprint established, and determining whether a change to at least one fingerprint established and/or a network element without an established fingerprint has been introduced within the communications network. Still further, the method may involve providing notice of the change and/or the network element without an established fingerprint.

### TECHNICAL FIELD

The present invention generally relates to detecting incidents within a communications network and, more particularly, relates to profiling or fingerprinting network elements to detect hacker intrusions within a communications network.

### BACKGROUND

Communications network security is not only critical today to diminish the impact of technical problems before communication is hindered but to counter attempts by hackers to sabotage communication. In today's environment each communications operating company needs to intimately know the structure of their communications network, for example signaling system 7 (SS7) networks, and make sure the network is secure in every respect. Communication companies that provide government communication services have an additional responsibility to provide an extra layer of security to counter threats to network functionality and/or privacy.

Many communications network incidents are not identified until it is too late and network processing has ceased. Even after problems are discovered it is often difficult to determine through investigation where the incident originated and how it developed. Thus, when a change occurs in the structure of message communications, previous systems do not have a way of proactively identifying the change and the origin of the change. There is a great deal of information on a communications network. Thus, administrators may unknowingly allow undetected and intruding information to be present within the network. Therefore without a way to detect information within a communications network and to know when there's an intruder, network communications remain vulnerable.

Accordingly there is an unaddressed need in the industry to address the aforementioned deficiencies and inadequacies.

### SUMMARY

Embodiments of the present invention provide methods, computer program products, and systems for detecting incidents within a communications network. A way to help in detecting a communications network attack/intrusion and in investigating an attack or incident, should one occur, is to establish a fingerprint of one or more network elements associated with the communications network, for instance a Signaling System 7 (SS7) Network. As defined herein the term fingerprint includes messages, responses, message signaling characteristics and parameters, and/or a point code of a network element associated with the communications network. Any time there is a network element without an existing fingerprint introduced or a change in an existing fingerprint, then action can be taken immediately.

One embodiment is a method for detecting an incident within a communications network. The communications network is associated with network elements. The method involves establishing a fingerprint for at least one of the network elements associated with the communications network. Each fingerprint established includes at least one message signaling characteristic and/or at least one message signaling parameter of a network element. The method also involves monitoring message communications within the communications network, comparing the message communications monitored to each fingerprint established, and determining whether a change to an established fingerprint and/or a network element without a fingerprint has been introduced within the communications network. The method may also involve providing notice of the change and/or network element without a fingerprint.

Still further, the method may involve establishing a fingerprint for each of the network elements by capturing messages sent from each of the network elements for each message type supported by a network element for which the fingerprint is being established, recording the messages captured as at least part of the fingerprint for that network element sending the message, and generating messages to the network elements. Additionally, the method may involve capturing responses to the messages generated from the network elements for each message type supported by a network element for which the fingerprint is being established, recording the responses captured as at least part of the fingerprint for that network element responding, and recording a unique point code for each network element as at least part of the fingerprint for that network element. Each fingerprint established is specific to a network element and specific to a function of the network element in the communications network.

Another embodiment is a computer program product including a computer-readable medium having control logic stored therein for causing a computer to detect an incident within a communications network where the communications network is associated with network elements. The control logic includes computer-readable program code for causing the computer to establish a fingerprint for at least one of the network elements associated with the communications network where each fingerprint established includes at least one message signaling characteristic and/or at least one message signaling parameter of one of the network elements. The control logic also includes computer-readable program code for causing the computer to monitor message communications within the communications network, compare the message communications monitored to each fingerprint established, and determine whether a change to at least one fingerprint established has been introduced within the communications network.

Still another embodiment is a system for detecting an incident within a communications network, wherein the communications network is associated with network elements. The system includes a computing apparatus operative to establish a fingerprint for at least one of the network elements associated with the communications network, monitor message communications within the communications network, compare the message communications monitored to each fingerprint established, and determine whether a change to at least one fingerprint established has been introduced within the communications network.

Other systems, computer program products, methods, features, and advantages of the present invention will be or become apparent to one with skill in the art upon examination of the following drawings and detailed description. It is intended that all such additional systems, methods, features, and advantages be included within this description, be within the scope of the present invention, and be protected by the accompanying claims.

### BRIEF DESCRIPTION OF THE DRAWINGS

FIG. 1 is a schematic diagram illustrating components of a SS7 network, a PSTN network, an advanced intelligent telecommunications network (AIN), and network message analyzer (NMA) components that provide an illustrative operating environment for the invention;

FIG. 2 illustrates computing apparatus architecture for the NMA of FIG. 1 utilized in an illustrative embodiment of the invention;

FIG. 3 is a block diagram illustrating a structure of network element fingerprints according to an illustrative embodiment of the invention;

FIG. 4 illustrates an operational flow performed in detecting incidents within a communications network according to an illustrative embodiment of the invention; and

FIG. 5 illustrates an operational flow performed in establishing a fingerprint for each network element according to an illustrative embodiment of the invention.

### DETAILED DESCRIPTION

As described briefly above, embodiments of the present invention provide methods, systems, and computer program products for detecting incidents within a communications network. In the following detailed description, references are made to accompanying drawings that form a part hereof, and in which are shown by way of illustration specific embodiments or examples. These illustrative embodiments may be combined, other embodiments may be utilized, and structural changes may be made without departing from the spirit and scope of the present invention. The following detailed description is, therefore, not to be taken in a limiting sense, and the scope of the present invention is defined by the appended claims and their equivalents.

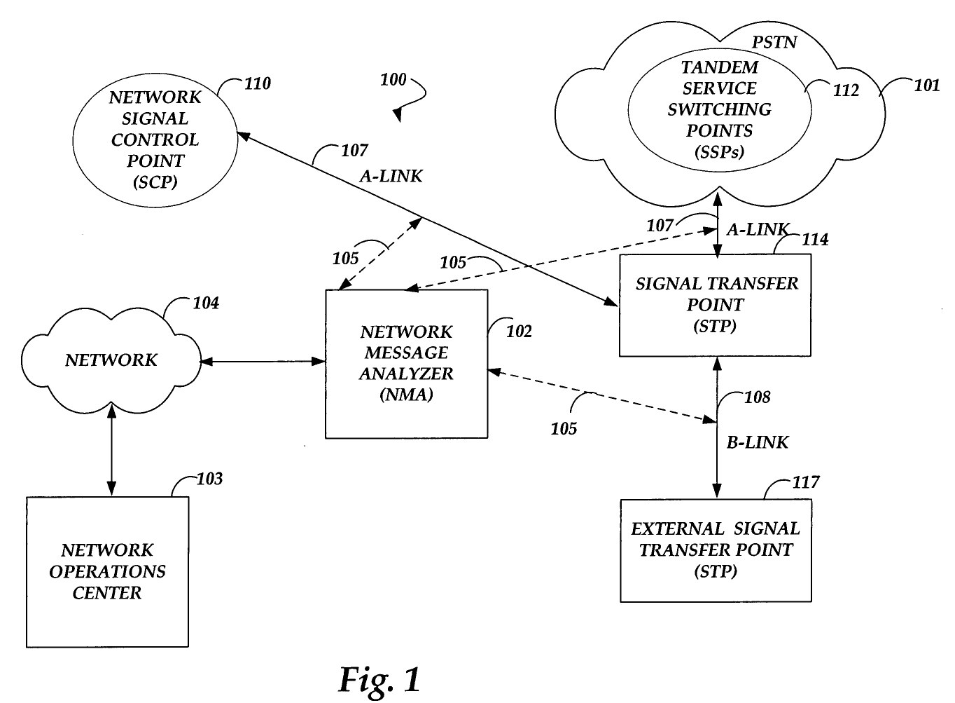

Referring now to the drawings, in which like numerals represent like elements through the several figures, aspects of the present invention and the illustrative operating environment will be described. FIGS. 1-3 and the following discussion are intended to provide a brief, general description of a suitable computing environment in which the embodiments of the invention may be implemented. While the invention will be described in the general context of program modules that execute in conjunction with a BIOS program that executes on a personal or server computing apparatus, those skilled in the art will recognize that the invention may also be implemented in combination with other program modules.

Generally, program modules include routines, operations, programs, components, data structures, and other types of structures that perform particular tasks or implement particular abstract data types. Moreover, those skilled in the art will appreciate that the invention may be practiced with other computer system configurations, including hand-held devices, multiprocessor systems, microprocessor-based or programmable consumer electronics, minicomputers, mainframe computers, and the like. The invention may also be practiced in distributed computing environments where tasks are performed by remote processing devices that are linked through a communications network. In a distributed computing environment, program modules may be located in both local and remote memory storage devices.

It is advantageous to describe an illustrative operating environment in which the present invention may operate. FIG. 1 is a schematic diagram illustrating components of a Signaling System 7 (SS7) network, a Public Switched Telephone Network (PSTN) network, an Advanced Intelligent telecommunications Network (AIN), and Network Message Analyzer (NMA) components that provide an illustrative operating environment 100 for the invention and include a general description of a modern PSTN through which an embodiment of the present invention operates. The modern PSTN has separate signaling paths for voice signals (or other customer-utilized communication circuits) and for control signals, which include information transmitted throughout the network to control the connection and disconnection of the voice circuits. Voice signals are typically carried through trunk connections, while control signals are carried across the SS7 network.

The PSTN also incorporates the AIN. Some of the AIN components are illustrated in FIG. 1. The AIN also uses the SS7 network for signal or system control message transport. The components thereof are well known in the art. However, it should be appreciated that other protocols, such as the Session Initiation Protocol (SIP), a TCP/IP-based protocol may be used for signal or system control message transport.

After a communications network attack incident has occurred, then fingerprints from before and after the incident can be compared to establish where in the communications network the incident originated. Communications network element fingerprinting as defined herein includes a process to identify specific signaling characteristics and signaling parameters of one or more network elements within the communications network, such as an SS7 Network, and then record each of these characteristics and parameters by network element. Also, the order of appearance of the characteristics and parameters may be important as each message is received. Each network element has unique signaling parameters and signaling characteristics associated with it based on each vendor's interpretation of the Telecordia Generic Requirements (GR) Signaling documents. Once these signaling parameters and characteristics are recorded, then a comparison may be executed on an hourly, daily, weekly, or monthly interval to verify no new network elements without a fingerprint have been introduced or no changes to any existing network element has occurred. The signaling parameters and characteristics may be recorded in raw ANSI SS7 format and in a spreadsheet. Fingerprinting each network element is one way to insure security and investigate incidents.

Referring still to FIG. 1, a plurality of central offices is provided in a typical PSTN 101. Each central office may include an electronic switch, for instance a service switching point (SSP) or other switches. These are indicated in FIG. 1 as tandem SSP switches 112. The number of SSP switches depends on the number of subscribers to be served by the PSTN 101. An SSP is the AIN component of a typical electronic central office switch used by a local exchange carrier. The terms “SSP” and “switch” are used interchangeably hereinafter and are understood to refer to a telecommunications switch having AIN capability and which may be utilized for connecting voice channel circuits, including voice channel lines, such as trunk circuits.

Each piece of terminating equipment in the PSTN is assigned a directory number. The terms “telephone directory number”, “telephone number”, and “directory number” are used herein in a manner consistent with its generally understood meaning of a number that is dialed or input by an originating or calling party at an originating station to reach a terminating station associated with the directory number. A directory number, typically a ten digit number, is commonly referred to as a “telephone number” and may be assigned to a specific telephone line.

Much of the intelligence, and the basis for many of the enhanced features of the network, resides in a local Service Control Point (SCP) 110 that has a database containing subscriber information, and is connected to a Signal Transfer Point (STP) 114 via an SS7 data A link 107. As is known to those skilled in the art, relatively powerful fault tolerant computers physically implement SCPs, such as SCP 110. Among the functions performed by the SCPs is maintenance of the network databases used in providing enhanced services and the execution of Service Package Applications (SPA).

In operation, the intelligent network elements of the operating environment 100, as described above, communicate with each other via digital data messages transmitted over the network of digital data links 107 and 108 which may include A, B, D, and/or F links. An SSP may be configured to interface with these network elements through the use of a terminating attempt trigger (TAT) (not shown). A trigger in the network is an event associated with a particular subscriber line or call that causes the SSP 112 to generate a data packet message to be sent to an SCP. It should be appreciated that the call reaching the TAT may originate from the telephone of a calling party, from a computer, from the Internet, or from other communications signal sending equipment.

The message created by the SSP 112 in response to the TAT is known as a “query” message. A query message opens a “transaction” and the SSP generally holds the communication until it receives a reply from an appropriate network element via the network of digital links instructing the SSP 112 to take action. If the SSP 112 receives no instructions with a certain amount of time, the SSP “times out” and executes a default task for the communication. The reply to the query message may be a “conversation” message or a “response” message. Conversation messages allow for bi-directional exchanges between network elements while the transaction remains open. A “response” message closes the transaction opened by the query message, and usually instructs the SSP 112 to route the held communication for connection with a terminating station. Query messages, conversation messages, and response messages are standard types of messages defined by the AIN protocol. The details of the AIN protocol are known to those skilled in the art and will not be further described herein.

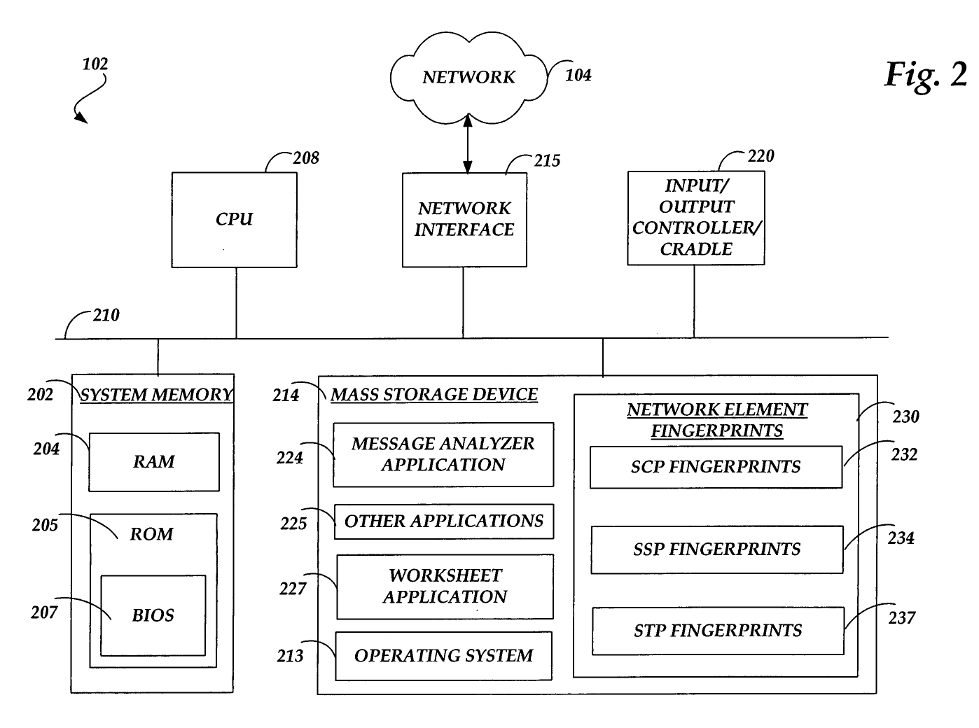

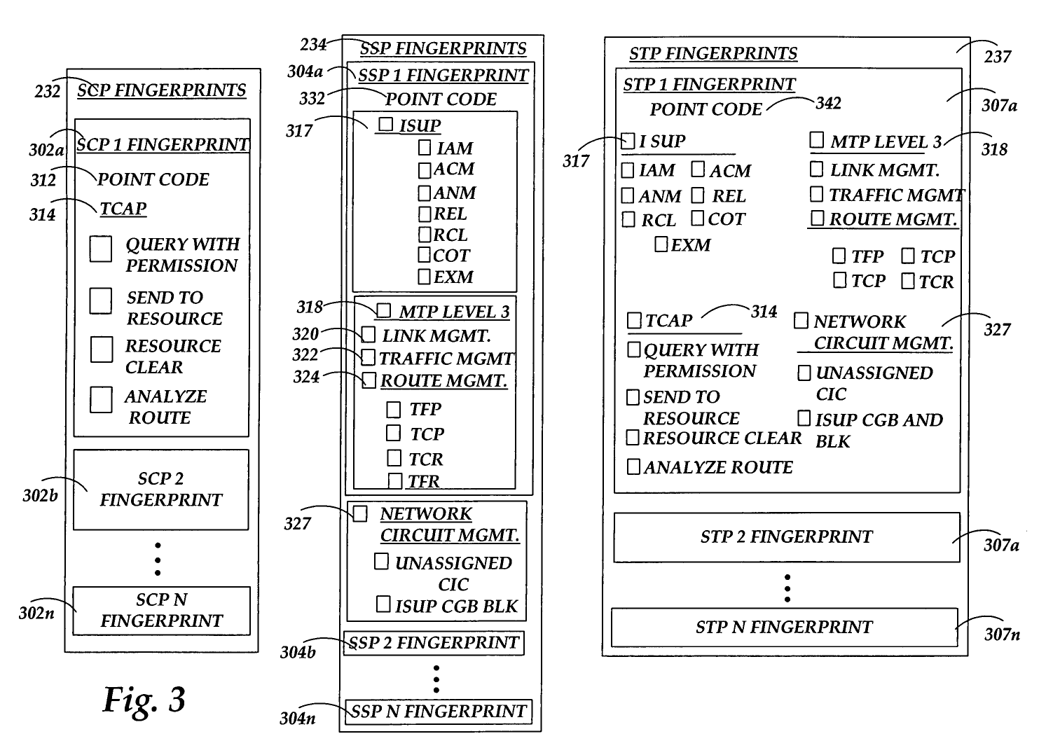

A network message analyzer (NMA) 102 interfaces with signal transfer point (STP) 114 where all message signaling is processed via connectors 105 connected to A links 107 and B link 108. In certain networks, gateway STPs are used. Gateway STPs are components by which calls from outside the carrier network enter the carrier network and through which queries reach an SCP. An external STP 117 may send and receive messages to the communications network via the STP 114 by way of the B link 108. The NMA 102 monitors inbound and outbound messages to, from, and within the carrier network collecting data from protocol messages. The NMA 102 captures the information necessary to establish fingerprints of network elements associated with the communications network and monitors communications to detect incidents. When an incident occurs, the NMA 102 provides notice of the incident by transmitting an alarm to a network operations center 103 via a network 104, for example a TCP/IP network. Additional details regarding the NMA 102 will be describe below with respect to FIGS. 2 and 3.

FIG. 2 illustrates a computing apparatus architecture for the NMA 102 of FIG. 1 utilized in an illustrative embodiment of the invention. The NMA 102 may be a standard portable personal computer such as the AGILENT SIGNALING ADVISOR from AGILENT CORPORATION of the United Kingdom. The NMA 102 includes a central processing unit 208, a system memory 202, and a system bus 210 that couples the system memory 202 to the CPU 208. The system memory 202 includes read-only memory (ROM) 205 and random access memory (RAM) 204. A basic input/output system 207 (BIOS), containing the basic routines that help to transfer information between elements within the NMA 102, such as during start-up, is stored in ROM 205. The NMA 102 further includes a mass storage device (MSD) 214 for storing an operating system 213 such as WINDOWS XP, from MICROSOFT CORPORATION of Redmond, Wash., a message analyzer application 224 for establishing fingerprints and monitoring message communications, a worksheet application 227 for storing and analyzing fingerprint data, and other applications 225, for example a word processing and/or a web browser application. It should be appreciated that the MSD 214 may be a redundant array of inexpensive discs (RAID) system for storing data including software capable of supporting a TCP/IP or other protocol stack.

The message analyzer application 224 establishes the fingerprints of the network elements, for example the SCP 110, the SSPs 112, the STP 114, and the external STP 117. The fingerprints are stored in a network element fingerprint database 230. Each fingerprint is specific to a network element and the network element's function in the communications network. Thus, SCP fingerprints 232, SSP fingerprints 234, and STP fingerprints 237 are stored in the database 230 and may be stored in the worksheet application 227. Additional details regarding establishing fingerprints and detecting incidents will be described below with respect to FIGS. 3, 4, and 5.

The MSD 214 is connected to the CPU 208 through a mass storage controller (not shown) connected to the system bus 210. The MSD 214 and its associated computer-readable media, provide non-volatile storage for the NMA 102. Although the description of computer-readable media contained herein refers to a mass storage device, such as a hard disk or RAID array, it should be appreciated by those skilled in the art that computer-readable media can be any available media that can be accessed by the CPU 208.

An input/output controller/cradle 220 may also be included with the NMA 102 for receiving and processing input from a number of input devices such as the connectors 105. The input/output controller 220 communicates with the CPU 208 through the system bus 210.

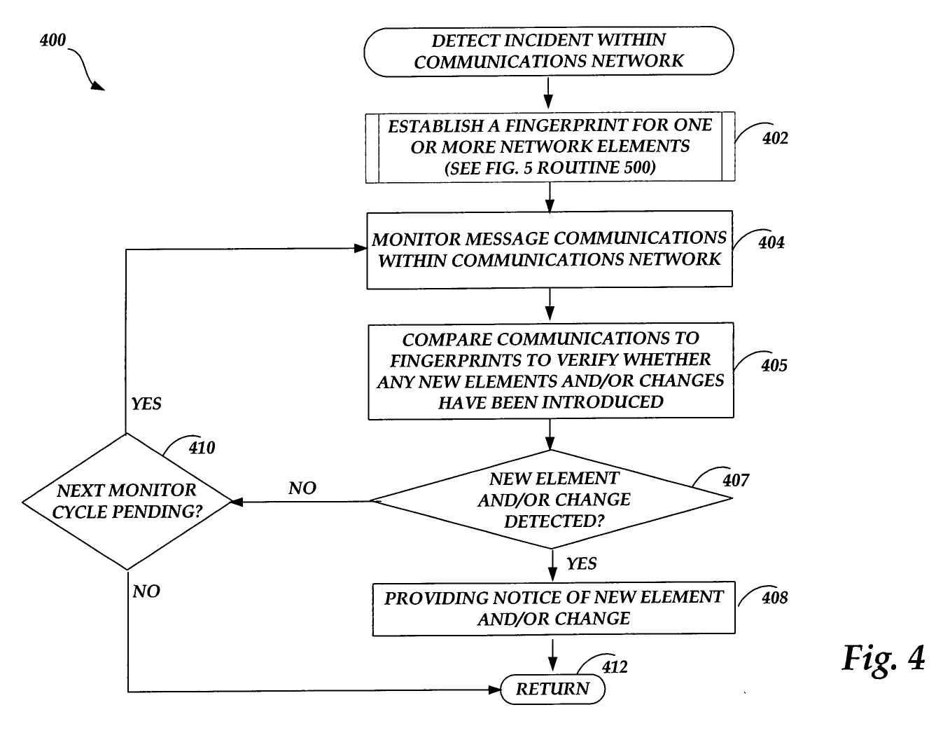

The CPU 208 may employ various operations, discussed in more detail below with reference to FIGS. 3 and 4 to provide and utilize the signals propagated between the NMA 102 and the communications network. The CPU 208 may store data to and access data from MSD 214, such as electronic memory or magnetic storage. Data is transferred to and received from the MSD 214 through the system bus 210. The CPU 208 may be a general-purpose computer processor. Furthermore as mentioned below, the CPU 208, in addition to being a general-purpose programmable processor, may be firmware, hard-wired logic, analog circuitry, other special purpose circuitry, or any combination thereof.

According to various embodiments of the invention, the NMA 102 operates in a networked environment, as shown in FIG. 1, using logical connections to remote computing devices via network communication, such as an Intranet, or a local area network (LAN). The NMA 102 may connect to the network 104 via a network interface unit 215. It should be appreciated that the network interface unit 215 may also be utilized to connect to other types of networks and remote computer systems.

A computing apparatus, such as the NMA 102, typically includes at least some form of computer-readable media. Computer readable media can be any available media that can be accessed by the NMA 102. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, disk drives, a collection of disk drives, flash memory, other memory technology or any other medium that can be used to store the desired information and that can be accessed by the NMA 102.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

FIG. 3 is a block diagram illustrating a structure of network element fingerprints according to an illustrative embodiment of the invention. The SCP fingerprints 232 may include SCP fingerprints 302a-302n for each SCP associated with the communications network where n is the number of associated SCPs. An SCP 1 fingerprint 302a, as does each SCP fingerprint, includes a point code 312 identifying and distinguishing the SCP 1 network element from other network elements. The SCP 1 fingerprint 302a also includes Transactional Capabilities Application Part (TCAP) type 314 messages such as query with permission, send to resource, resource clear and analyze route. Point codes and the TCAP message type 314 are known in the art.

The SSP fingerprints 234 may include SSP fingerprints 304a-304n for each SSP associated with the communications network where n is the number of associated SSPs. An SSP 1 fingerprint 304a, as does each SSP fingerprint, includes a point code 332 identifying and distinguishing the SSP 1 network element from other network elements. The SSP 1 fingerprint 304a also includes Integrated Services Digital Network User Part (ISUP) type 317 messages such as initial address messages (IAM), address complete messages (ACM), answer messages (ANM), release messages (REL), release complete messages RLC, continuing check messages (COT), and exit message (EXM). The ISUP message type 317 is known in the art.

The SSP 1 fingerprint 304a also includes Message Transfer Part (MTP) type 318, for example level 3, messages such as link management messages 320, traffic management messages 322, and route management messages 324. The route management messages 324 may include transfer prohibits (TFP), transfer restrictions (TFR), transmission control protocol (TCP) and transaction confirmation report (TCR). The MTP message type 318 is known in the art. The SSP 1 fingerprint 304a also includes network, for example SS7, circuit management type 327 messages such as unassigned circuit identification code (CIC) messages and ISUP, circuit group blocking (CGB), and block (BLK) messages.

The STP fingerprints 237 may include STP fingerprints 307a-307n for each STP associated with the communications network where n is the number of associated STPs. An STP 1 fingerprint 307a, as does each STP fingerprint, includes a point code 342 identifying and distinguishing the STP 1 network element from other network elements. The STP 1 fingerprint 307a also includes the ISUP type 317 messages, the MTP type 318 messages, the TCAP type 314 messages, and the network circuit management type 327 messages describe above.

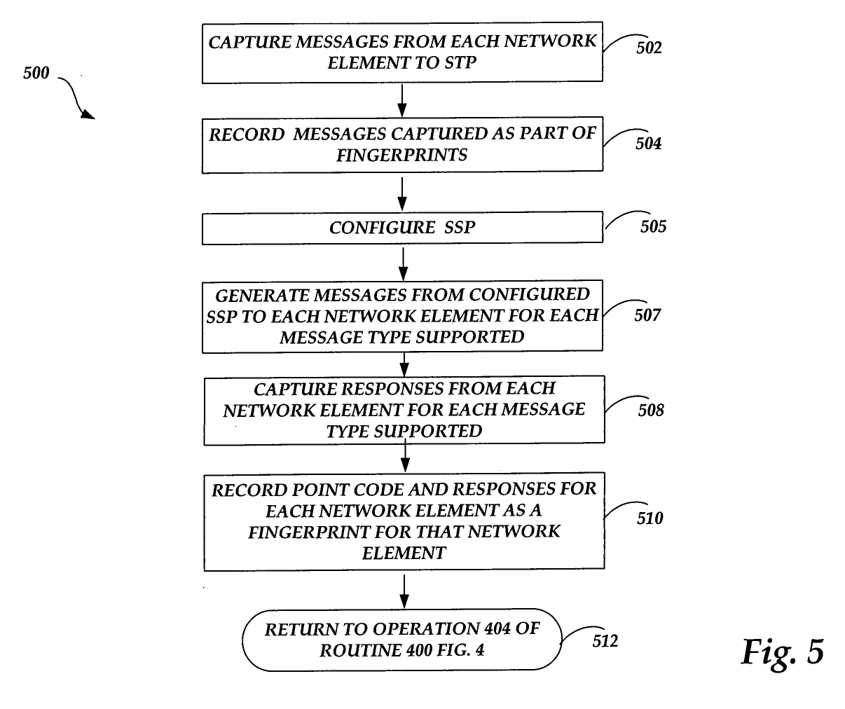

Referring now to FIGS. 1, 3, and 4 an operational flow for a routine 400 performed in detecting incidents within a communications network according to an illustrative embodiment of the invention will be described. The routine 400 begins with operation 402 where the NMA 102 establishes a fingerprint for at least one of the network elements associated with the communications network. The NMA 102 establishes fingerprints of the network elements utilizing the connectors 105 as described above with regard to FIGS. 1 and 3. Each fingerprint established includes at least one message signaling characteristic and/or at least one message signaling parameter of one of the network elements. Additional details regarding establishing fingerprints will be described below with respect to FIG. 5.

The routine 400 then continues to operation 404 where the NMA 102 monitors message communications within the communications network. The routine 400 then continues to operation 405 where the NMA 102 compares the monitored message communications to the established fingerprints to verify whether any changes to network elements that have established fingerprints have been introduced and/or whether any network elements without fingerprints have been introduced within the communications network. Comparing the message signaling characteristics of the message communications monitored to each fingerprint established may include comparing a sequence of signaling parameters and/or a quantity of signaling parameters to a sequence of signaling parameters recorded and/or a quantity of signaling parameters recorded in each fingerprint established. The routine 400 then continues to operation 407.

At operation 407, the NMA 102 determines whether a change to at least one network element having a fingerprint established has been introduced and/or whether a network element without a fingerprint has been introduced within the communications network. When no changes and/or network elements are detected at operation 407, the routine 400 continues to operation 410 where the NMA 102 determines whether a next monitor cycle is pending. The communications network may be monitored continuously or on a periodic basis, such as hourly, daily, monthly etc. When the next monitor cycle is pending, the routine 400 continues from operation 410 to operation 404 described above. When the next monitor cycle is not pending the routine 400 continues from operation 410 to return operation 412 where control is passed to other routines.

When at operation 407 a change and/or a network element without a fingerprint is detected, the routine 400 continues to operation 408. At operation 408 the NMA 102 provides notice of the change and or newly introduced network element. This notice may be in the form of an alarm transmission to the network operations center 103 via the network 104. The routine 400 then continues to return operation 412 described above.

Turning now to FIGS. 1, 3, and 5 an operational flow for a routine 500 performed in establishing a fingerprint for each network element according to an illustrative embodiment of the invention will be described. Each fingerprint established is specific to a network element and specific to a function of the network element in the communications network. The routine 500 begins at operation 502 where the NMA 102 captures messages sent from at least one of the network elements to the STP 114.

The routine 500 then continues to operation 504 where the NMA 102 records the messages captured as at least part of the fingerprint for the network element sending the message captured. For example, in a SS7 network the recorded messages captured may include message signaling parameters such as calling and called telephone directory numbers, and a termination status for each captured message. The termination status refers to an indicator as to whether a monitored message is terminated or answered.

Next the routine 500 continues to operation 505 where the NMA 102 configures itself as an SSP. The routine 500 then continues to operation 507 where the NMA 102 generates messages as the configured SSP to at least one of the network elements, such as the SCP 110. The routine 500 then continues to operation 508.

At operation 508, the NMA 102 captures responses to the messages generated from at least one of the network elements. It should be appreciated that the captured messages and responses may be captured for each message type supported by an individual network element. For instance, the SCP 114 supports the TCAP 314 type message whereas in contrast the external STP 117 supports the TCAP 314, the ISUP 317, the MTP 318 level 3, and the network circuit management 327 type messages.

The routine 500 then continues to operation 510 where the NMA 102 records the responses captured as at least part of the fingerprint and records a unique point code associated with the network element as at least part of the fingerprint. The routine 500 then returns to operation 404 of FIG. 4 described above.

Thus, the present invention is presently embodied as methods, systems, computer program products or computer readable mediums encoding computer programs for detecting an incident within a communications network.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method for detecting an incident within a communications network, the communications network associated with a network element, the method comprising:
establishing a fingerprint for the network element associated with the communications network wherein the fingerprint established includes at least one of a message signaling characteristic and a message signaling parameter of the network element;
monitoring message communications within the communications network;
comparing the message communications monitored to the fingerprint; and
determining whether a change to the network element having the fingerprint has been introduced within the communications network.

2. The method of claim 1, further comprising in response to determining that the change to the fingerprint has been introduced, providing notice of the change.

3. The method of claim 2, wherein providing notice comprises transmitting an alarm to a network operations center and wherein comparing the message communications monitored comprises comparing the message communications monitored to the fingerprint established.

4. The method of claim 1, wherein establishing the fingerprint for the network element comprises establishing a fingerprint for each of the network elements, the method further comprising:
determining whether a network element without an established fingerprint has been introduced within the communications network; and
in response to determining that the network element without an established fingerprint has been introduced, providing notice of the network element without an established fingerprint.

5. The method of claim 4, wherein comparing at least one of the message communications monitored to each fingerprint established comprises comparing message signaling characteristics and message signaling parameters of the message communications monitored to each fingerprint established wherein each fingerprint established includes each message signaling characteristic and each message signaling parameter of the one of the network elements for which that fingerprint is established.

6. The method of claim 1, wherein determining whether the change to the at least one fingerprint established has been introduced comprises determining whether an intrusion from a hacker has occurred within the communications network.

7. The method of claim 1, wherein monitoring message communications comprises monitoring at least one of messages sent from and responses sent from the at least one of the network elements and wherein establishing the fingerprint for the at least one of the network elements comprises:
(a) capturing messages sent from the at least one of the network elements;
(b) recording the messages captured as at least part of the fingerprint;
(c) generating messages to the at least one of the network elements;
(d) capturing from the at least one of the network elements, responses to the messages generated;
(e) recording the responses captured as at least part of the fingerprint;
repeating (a)-(e) for each message type supported by the at least one of the network elements for which the fingerprint is being established; and
recording a point code associated with the at least one of the network elements as at least part of the fingerprint;
wherein each fingerprint established is specific to a network element and specific to a function of the network element in the communications network.

8. The method of claim 7, further comprising configuring a service switching point wherein generating messages to the at least one of the network elements comprises generating messages from the service switching point configured.

9. The method of claim 7, wherein repeating (a)-(e) for each message type supported by the at least one of the network elements for which the fingerprint is being established comprises repeating (a)-(e) for at least one the following:
an ISUP message type wherein at least one of the messages and responses captured comprise at least one of an IAM, an ACM, an ANM, a REL, a RLC, a COT, and an EXM message;
a TCAP message type wherein at least one of the messages and responses captured comprise a query with permission message, a send to resource message, a resource clear message, and an analyze route message;
a MTP message type wherein at least one of the messages and responses captured comprise at least one of a link management message, a traffic management message, and a route management message, the route management message comprising at least one of a TFP, a TCP, a TCR, and a TFR; and
a SS7 circuit management message wherein at least one of the messages and responses captured comprise at least one of an unassigned CIC message, an ISUP message, a CGB message, and a BLK message;
wherein the network elements comprise at least one of an SSP, an STP internal to the communications network, an STP external to the communications network, and an SCP.

10. The method of claim 5, wherein comparing the message signaling characteristics of the message communications monitored to each fingerprint established comprising comparing at least one of a sequence of signaling parameters and a quantity of signaling parameters to at least one of a sequence of signaling parameters recorded and a quantity of signaling parameters recorded in each fingerprint established.

11. A computer program product comprising a computer-readable medium having control logic stored therein for causing a computer to detect an incident within a communications network, wherein the communications network is associated with a network element, the control logic comprising computer-readable program code for causing the computer to:
establish a fingerprint for the network element associated with the communications network wherein the fingerprint established includes at least one of a message signaling characteristic and a message signaling parameter of the network element;
monitor message communications within the communications network;
compare the message communications monitored to the fingerprint established; and
determine whether a change to the fingerprint has been introduced within the communications network.

12. The computer program product of claim 11, wherein the computer-readable program code is further operative to cause the computer to in response to determining that the change to the at least one fingerprint established has been introduced, provide notice of the change.

13. The computer program product of claim 12, wherein the computer-readable program code operative to cause the computer to establish the fingerprint for the at least one of the network elements is operative to cause the computer to establish a fingerprint for each of the network elements, wherein the computer-readable program code is further operative to cause the computer to:
determine whether a network element without an established fingerprint has been introduced within the communications network; and
in response to determining that the network element without an established fingerprint has been introduced, provide notice of the network element without an established fingerprint.

14. The computer program product of claim 13, wherein the at least one of the message communications monitored comprises at least one of message signaling characteristics and message signaling parameters of the message communications monitored and wherein each fingerprint established includes each message signaling characteristic and each message signaling parameter of the one of the network elements for which that fingerprint is established.

15. The computer program product of claim 11, wherein the computer-readable program code for causing the computer to monitor the message communications is operative to cause the computer to monitor at least one of messages sent from and responses sent from the at least one of the network elements and wherein the computer-readable program code for causing the computer to establish the fingerprint for the at least one of the network elements is operative to cause the computer to:
(a) capture messages sent from the at least one of the network elements;
(b) record the messages captured as at least part of the fingerprint;
(c) generate messages to the at least one of the network elements;
(d) capture from the at least one of the network elements, responses to the messages generated;
(e) record the responses captured as at least part of the fingerprint;
repeat (a)-(e) for each message type supported by the at least one of the network elements for which the fingerprint is being established; and
record a point code associated with the at least one of the network elements as at least part of the fingerprint;
wherein each fingerprint established is specific to a network element and specific to a function of the network element in the communications network.

16. A system for detecting an incident within a communications network, wherein the communications network is associated with a network element, comprising:
means for establishing a fingerprint for the network element associated with the communications network wherein the fingerprint established includes at least one of a message signaling characteristic and a message signaling parameter of the network element;
means for monitoring message communications within the communications network;
means for comparing the message communications monitored to the fingerprint established; and
means for determining whether a change to the fingerprint has been introduced within the communications network.

17. The system of claim 16, wherein the computing apparatus is further operative to in response to determining that the change to the at least one fingerprint established has been introduced, provide notice of the change.

18. The system of claim 17, wherein the computing apparatus is operative to establish a fingerprint for each of the network elements and wherein the computing apparatus is further operative to:
determine whether a network element without an established fingerprint has been introduced within the communications network; and
in response to determining that the network element without an established fingerprint has been introduced, provide notice of the network element without an established fingerprint.

19. The system of claim 18, wherein the at least one of the message communications monitored comprises at least one of message signaling characteristics and message signaling parameters of the message communications monitored and wherein each fingerprint established includes each message signaling characteristic and each message signaling parameter of the one of the network elements for which that fingerprint is established.

20. The system of claim 16, wherein the message communications comprise at least one of messages sent from and responses sent from the at least one of the network elements and wherein when establishing the fingerprint for the at least one of the network elements, the computing apparatus is operative to:
(a) capture messages sent from the at least one of the network elements;
(b) record the messages captured as at least part of the fingerprint;
(c) generate messages to the at least one of the network elements;
(d) capture from the at least one of the network elements, responses to the messages generated;
(e) record the responses captured as at least part of the fingerprint;
repeat (a)-(e) for each message type supported by the at least one of the network elements for which the fingerprint is being established; and
record a point code associated with the at least one of the network elements as at least part of the fingerprint;
wherein each fingerprint established is specific to a network element and specific to a function of the network element in the communications network.
